(19) United States
(12) Patent Application Publication
(10) Pub. No.: US 2013/0223516 A1
(43) Pub. Date: Aug. 29, 2013

(54) BLOCK QUANTIZER IN H.264 WITH REDUCED COMPUTATIONAL STAGES

(71) Applicants: Eran Goldstein, Raanana (IL); Shai Kalfon, Hod Hasharon (IL)

(72) Inventors: Eran Goldstein, Raanana (IL); Shai Kalfon, Hod Hasharon (IL)

(21) Appl. No.: 13/408,437

(22) Filed: Feb. 29, 2012

(51) Int. Cl. H04N 7/26

(52) U.S. Cl. 375/240.03; 375/E07.126

(57) ABSTRACT

An apparatus including a first circuit, a second circuit, a third circuit, and a fourth circuit. The first circuit may be configured to generate a first intermediate signal in response to a first input signal and a second input signal. The first intermediate signal generally comprises a product of the first input signal and the second input signal. The second circuit may be configured to generate a second intermediate signal by selecting between a first value and a second value in response to a sign of the first signal. The third circuit may be configured to generate a third intermediate signal in response to the first intermediate signal and the second intermediate signal. The third intermediate signal generally comprises a sum of the first intermediate signal and the second intermediate signal. The fourth circuit may be configured to generate an output signal in response to the third intermediate signal and a third input signal.

### FIELD OF THE INVENTION

The present invention relates to video compression generally and, more particularly, to a method and/or apparatus for implementing a block quantizer in H.264 with reduced computational stages.

### BACKGROUND OF THE INVENTION

Transform and quantization processes are performed as a part of the H.264 video coding standard. The transform and quantization processes produce a lossy compression of a video signal. A quantization stage (or quantizer) maps an input signal with a range of values X to a quantized output signal with a reduced range of values Y. It is generally possible to represent the quantized signal with fewer bits than a corresponding representation of the original signal since the range of possible values is smaller (i.e., Y<X). In general, the quantization stage can be represented mathematically by the following Equation 1:

Y=floor(X/Q+f), EQ. 1

where f is the rounding coefficient and Q is the step size.

The H.264 standard was developed with a goal of balancing high quality compression methods and algorithmic complexity. The suggested quantizer implementation of the H.264 standard can be expressed by the following Equation 2:

Y=sign(X)×((abs(X)×M+f)>>Q);Q>0, EQ. 2

where M represents the weight given to the input to be quantized. The H.264 standard implementation of the quantizer eliminated a costly division process by adding multiplication and bit shift-right functions. In addition, the H.264 standard implementation of the quantizer added two new operations—a sign function and an absolute value function. A property of the H.264 standard implementation of the quantizer is that the operation of shifting an absolute positive number instead of a signed number has the effect of enlarging the area of the zero step. This phenomena occurs for f≦0.5, and results in the width of the zero step being up to twice the width of the other steps.

It would be desirable to implement a block quantizer in H.264 with reduced computational stages.

### SUMMARY OF THE INVENTION

The present invention concerns an apparatus including a first circuit, a second circuit, a third circuit, and a fourth circuit. The first circuit may be configured to generate a first intermediate signal in response to a first input signal and a second input signal. The first intermediate signal generally comprises a product of the first input signal and the second input signal. The second circuit may be configured to generate a second intermediate signal by selecting between a first value and a second value in response to a sign of the first signal. The third circuit may be configured to generate a third intermediate signal in response to the first intermediate signal and the second intermediate signal. The third intermediate signal generally comprises a sum of the first intermediate signal and the second intermediate signal. The fourth circuit may be configured to generate an output signal in response to the third intermediate signal and a third input signal.

The objects, features and advantages of the present invention include providing a method and/or apparatus for implementing a block quantizer in H.264 with reduced computational stages that may (i) use fewer computational stages when implemented in hardware, (ii) use fewer computational cycles when implemented in software, (iii) eliminate need for absolute and sign functions in an H.264 quantizer, (iv) be used for non H.264 quantizers, and/or (v) produce bit exact results without implementing the absolute and sign functions.

### BRIEF DESCRIPTION OF THE DRAWINGS

These and other objects, features and advantages of the present invention will be apparent from the following detailed description and the appended claims and drawings in which:

FIG. 1 is a block diagram illustrating various components of a compressed video system in accordance with a preferred embodiment of the present invention;

FIG. 2 is a block diagram illustrating an example encoder in accordance with an embodiment of the present invention;

FIG. 3 is a diagram illustrating a block quantizer in accordance with an embodiment of the present invention;

FIG. 4 is a diagram illustrating an example transfer function of the block quantizer of FIG. 3;

FIG. 5 is a diagram illustrating a processing unit that may be used in implementing an encoder in accordance with an example embodiment of the present invention.

### DETAILED DESCRIPTION OF THE PREFERRED EMBODIMENTS

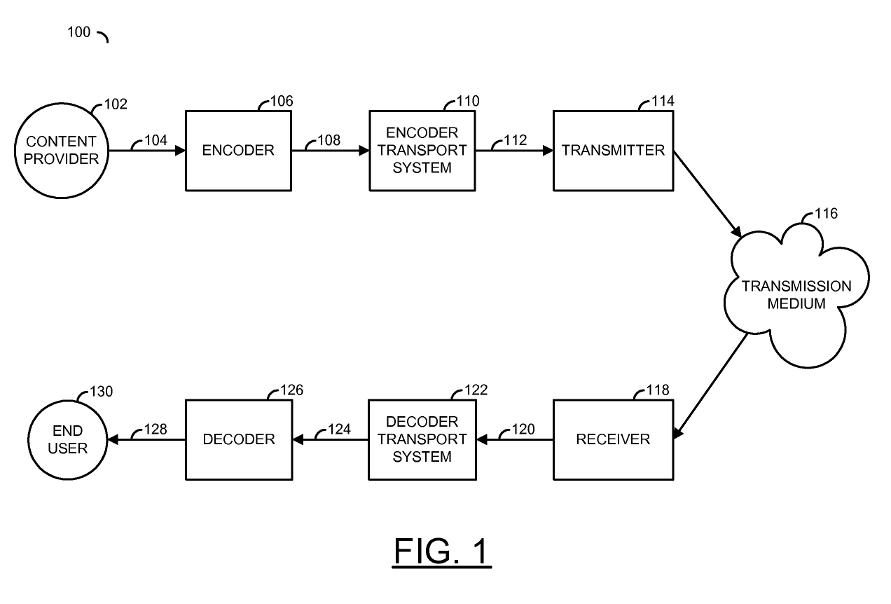

Referring to FIG. 1, a block diagram of a system 100 is shown illustrating components of a compressed video system in accordance with a preferred embodiment of the present invention. In general, a content provider 102 presents video image, audio and/or other data to be compressed and transmitted in a data stream 104 to an input of an encoder 106. The encoder 106 may be configured to generate a compressed bit stream 108 in response to the input stream 104. The encoder 106 may be configured to encode the data stream 104 according to one or more encoding standards (e.g., MPEG-1, MPEG-2, MPEG-4, WMV, VC-9, VC-1, H.262, H.263, H.264, H.264/JVC/AVC/MPEG-4 part 10, AVS 1.0 and/or other standards for compression of audio-video data). In one example, the encoder 106 may be further configured to generate the bit stream 108 using a quantization process implemented with a reduced number of computational stages in accordance with an embodiment of the present invention.

The compressed bit stream 108 from the encoder 106 may be presented to an encoder transport system 110. An output of the encoder transport system 110 generally presents a signal 112 to a transmitter 114. The transmitter 114 transmits the compressed data via a transmission medium 116. In one example, the content provider 102 may comprise a video broadcast, DVD, or any other source of video data stream. The transmission medium 116 may comprise, for example, a broadcast, cable, satellite, network, DVD, hard drive, or any other medium implemented to carry, transfer, and/or store a compressed bit stream.

On a receiving side of the system 100, a receiver 118 generally receives the compressed data bit stream from the transmission medium 116. The receiver 118 presents an encoded bit stream 120 to a decoder transport system 122. The decoder transport system 122 generally presents the encoded bit stream via a link 124 to a decoder 126. The decoder 126 generally decompresses (decodes) the data bit stream and presents the data via a link 128 to an end user hardware block (or circuit) 130. The end user hardware block 130 may comprise a television, a monitor, a computer, a projector, a hard drive, a personal video recorder (PVR), an optical disk recorder (e.g., DVD), or any other medium implemented to carry, transfer, present, display and/or store the uncompressed bit stream (e.g., decoded video signal).

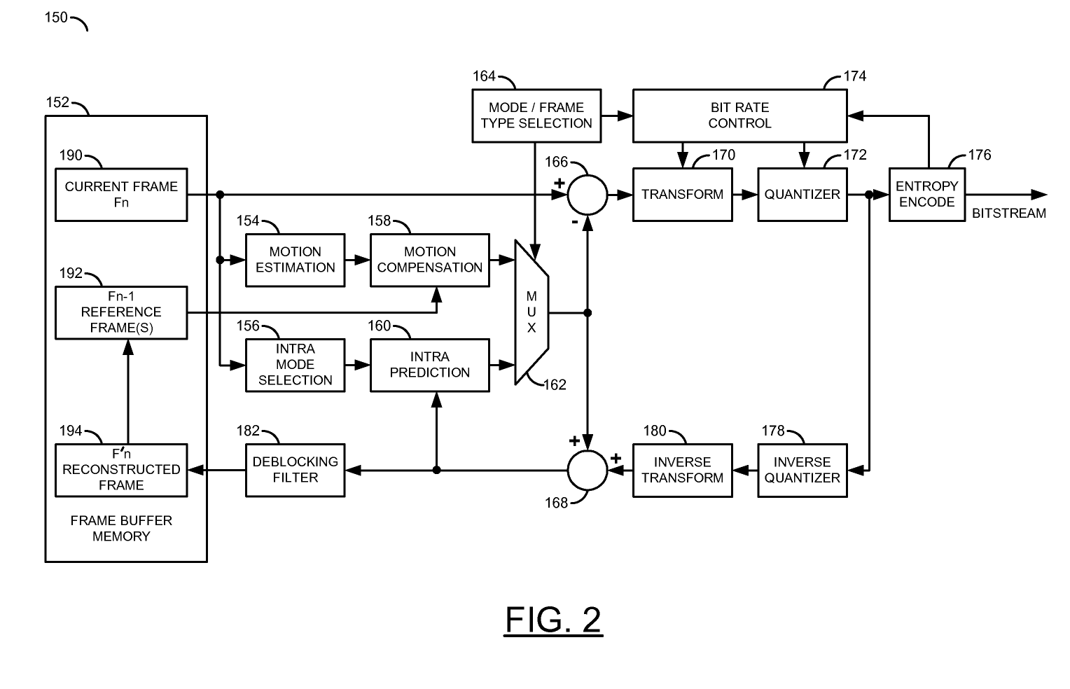

Referring to FIG. 2, a block diagram is shown illustrating an H.264 compliant encoder 150 implementing a block quantization process in accordance with an embodiment of the present invention. The encoder 150 may include a module 152, a module 154, a module 156, a module 158, a module 160, a module 162, a module 164, a module 166, a module 168, a module 170, a module 172, a module 174, a module 176, a module 178, a module 180, and a module 182. In one example, the modules 152-182 may represent circuits. In another example, the modules 152-182 may represent blocks that may be implemented as hardware, software, a combination of hardware and software, or other implementation.

The module 152 may be implemented, in one example, as a frame buffer memory. The module 154 may be implemented, in one example, as a motion estimation module. The module 156 may be implemented, in one example, as an intra mode selection module. The module 158 may be implemented, in one example, as a motion compensation module. The module 160 may be implemented, in one example, as an intra prediction module. The module 162 may be implemented, in one example, as a multiplexing module. The module 164 may be implemented, in one example, as a mode selection and frame type selection module. The modules 166 and 168 may be implemented, in one example, as adders. The module 170 may be implemented, in one example, as a transform module. The module 172 may be implemented, in one example, as a quantizer module. The module 172 may implement a quantization process in accordance with an example embodiment of the present invention. The module 174 may be implemented, in one example, as a control module. The module 174 may be configured, in one example, to control transformation and quantization processes based on bit rate parameters. The module 176 may be implemented, in one example, as an entropy encoding module. The module 178 may be implemented, in one example, as an inverse quantization module. The module 180 may be implemented, in one example, as an inverse transform module. The module 182 may be implemented, in one example, as a deblocking filter.

In one example, an H.264 compliant encoding process using the encoder 150 may comprise the following steps. An input frame (Fn) 190 may be stored in the memory 152. The input frame 190 may be broken up, in one example, into 16×16 blocks of luminance (Luma) pixels and associated chrominance (Chroma) pixels. The blocks of pixels are generally referred to as macroblocks. When the blocks are encoded, a prediction is generated. The prediction may be generated through inter prediction or intra prediction. An inter prediction (using Fn−1 reference frames) or an intra prediction (using neighbor blocks) may be calculated for each macroblock in the input frame 190. The prediction may be calculated such that a residual value created by subtracting the prediction block from the input block and a cost associated with the encoding of the prediction type are minimized.

The inter prediction is generally performed by the module 154 and the module 158. A sample (e.g., a macroblock) of the current frame 190 is presented to an input of the module 154 and an input of the module 156. The module 154 generates an output providing motion estimation information (e.g., motion vector, mode, etc.) for the macroblock. The output of the module 154 is presented to an input of the module 158. The module 158 generally performs motion compensation using one or more reference frame(s) 192. An output of the module 158 is presented to a first input of the module 162.

The module 156 generally performs the initial steps for intra prediction. The module 156 generally performs intra mode selection on the block of the current frame 190. An output of the module 156 is presented to a first input of the module 160. The module 160 may have a second input that may receive reconstructed image data from an output of the module 168. The module 160 generally performs intra prediction using the output from the module 156 and the reconstructed picture data from the module 168. An output of the module 160 is presented to a second input of the module 162. An output of the module 162 is presented to an input of the module 166 and an input of the module 168. The output of the module 162 generally presents a prediction based on either the inter mode processing or the intra mode processing. The output of the module 162 is generally selected in response to a control signal received from the module 164. The module 164 may have a second output that may present a signal to an input of the module 174. The module 174 may have a second input that may receive information from the module 176. The module 174 may have a first output that may be presented to a first input of the module 170 and a second output that may be presented to a first input of the module 172. Although the modules 164 and 174 are shown as separate modules, it will be apparent to a person of ordinary skill in the art that the modules 164 and 174 may also be implemented as a single circuit.

The residual pixels are generally calculated by the module 166 and presented to a second input of the module 170. The residual pixels are generally transformed into an array of frequency coefficients by the module 170. The module 170 generally presents the transformed pixels to a second input of the module 172. In the module 172, higher frequency components are quantized (divided) out, reducing the total number of coefficients in the block. The parameters used in quantizing the frequency coefficients are generally selected by the module 174 based upon information from the module 164 and feedback from the module 176. For example, the quantizer parameters may be selected to provide a predetermined bit rate. The coefficients are generally reordered so that the higher frequency coefficients are generally later in the list (e.g., by using a zigzag scan of the block into a linear array). The coefficients may then be sent to the entropy encoding engine 176. The entropy encoding engine 176 generally performs a lossless compression step that produces the final encoded bitstream (e.g., BITSTREAM).

The coefficients presented to the module 176 are also presented to an input of the module 178. The module 178 generally performs inverse quantization and passes the resulting coefficients to the module 180. The module 180 generally performs an inverse transform operation in order to create a reconstructed frame (F′n) 194. The reconstructed frame 194 is generally an exact copy of the reconstructed frame that would be generated by a decoder receiving the encoded bitstream. Optionally, the reconstructed block may be filtered before being stored in the frame buffer 152 by the deblocking filter 182. The reconstructed frame 194 may be promoted to a reference frame (F′r) 192 for use in generating the prediction of a next input frame (Fn+1).

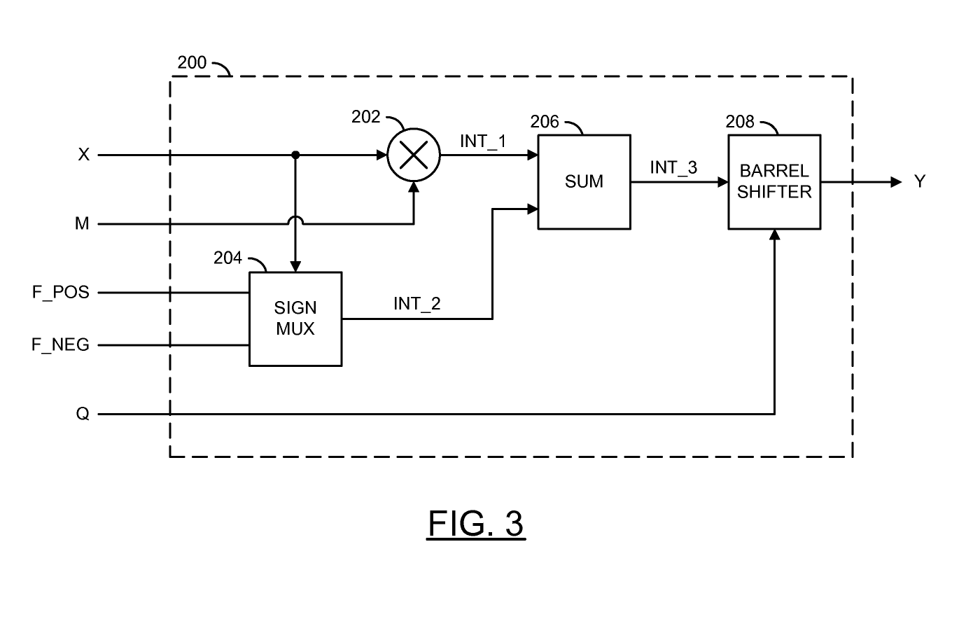

Referring to FIG. 3, a diagram is shown illustrating a block quantizer module 200 in accordance with an embodiment of the present invention. The block quantizer module 200 may be used to implement the quantizer block 172 in FIG. 2. The block quantizer module 200 may also be used to implement non H.264 quantizer blocks. In one example, the block quantizer module 200 may include a module 202, a module 204, a module 206 and a module 208. In one example, the modules 202-208 may represent circuits. In another example, the modules 202-208 may represent blocks that may be implemented as either hardware, software, a combination of hardware and software or other implementation.

The module 202 may be implemented, in one example, as a signed multiplier circuit. The module 204 may be implemented, in one example, as a multiplexing circuit. The module 206 may be implemented, in one example, as a summing circuit. The module 208 may be implemented, in one example, as a barrel shifter. The module 202 may have the first input that may receive a signal (e.g., X), a second input that may receive a signal (e.g., M), and an output that may present a first intermediate signal (e.g., INT_{—}1). The module 204 may have a first input that may receive the signal X, a second input that may receive a first value (e.g., F_POS), a third input that may receive a second value (e.g., F_NEG) and an output that may present a second intermediate signal (e.g., INT_2). The values F_POS and F_NEG may implement rounding coefficients for a quantization operation performed by the block quantizer module 200. The module 206 may have a first input that may receive the signal INT_1, a second input that may receive the signal INT_2, and an output that may present a third intermediate signal (e.g., INT_3). The module 208 may have a first input that may receive the signal INT_3, a second input that may receive an input signal (e.g., Q), and an output that may present an output signal (e.g., Y). Although the modules 202 and 206 are shown as separate modules, it will be apparent to a person of ordinary skill in the art that the modules 202 and 206 may also be implemented as a single circuit block (or macro). The signal Q may comprise information that determines a step size of the quantization process performed by the quantizer 200. The signal M may comprise a weighting factor to be applied to the signal X. In general, a larger weighting factor M results in less quantization (e.g., fewer bits of information lost). The signal Y may represent a quantized version of the signal X.

The block quantizer module 200 generally implements a H.264 quantizer using a mathematical manipulation over the process. The first stage is generally to insert the sign of X into the operation. However, the H.264 standard suggested bit shifter does not produce the same absolute value for negative numbers and positive numbers. The H.264 standard suggested quantizer implementation:

Y=sign(X)×((abs(X)×M+f)>>Q) EQ. 2

is not equivalent to

((X×M+sign(X)×f)>>Q. EQ. 3

In order for the barrel shifter 208 to produce a similar result to the H.264 standard suggested quantizer implementation, it necessary to use the following identity:

$$\begin{matrix}- ( \vert a \vert >> Q ) = ( ( - \vert a \vert + {1}_{Q} ) >> Q ) , \\ where \text{:} & EQ . 4 \\ \begin{matrix}{1}_{Q} = {2}^{Q} - 1 ; for Q > 0 \\ = 0 ; for Q \leq 0\end{matrix} & EQ . 5\end{matrix}$$

Using the above identity, the implementation of the quantization stage in accordance with an embodiment of the present invention may be expressed using the following Equation 6:

Y=((X×M+signmux(F_POS;F_NEG;X))>>Q), EQ. 6

where signmux is a function that chooses the value F_POS when the sign of X is positive and the value F_NEG when the sign of X is negative. The value F_POS is generally set equal to the H.264 standard rounding coefficient f. The value F_NEG generally equals −f+1_{Q}. Because the number of possible values for Q is generally small, the value 1_{Q} may be calculated offline, alongside the values {F_POS, F_NEG} for each value of Q. The values of F_POS and F_NEG for each value of Q may be stored in a look-up table (LUT) or in a memory (e.g., RAM, ROM, etc.). In one example, the values F_POS and F_NEG may be stored in the control circuit 174. In general, the values Q and M taken together define the amount of quantization (e.g., how many bits of information are to be removed) that is performed on the signal X.

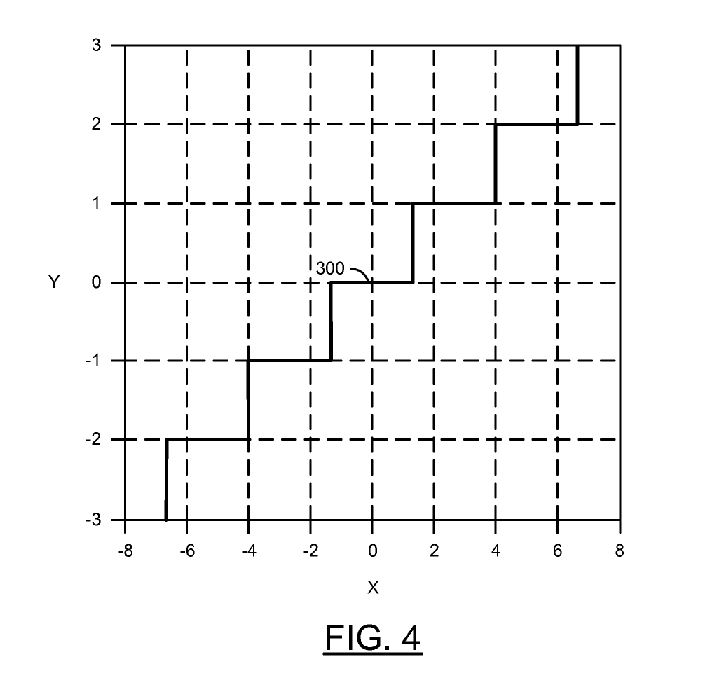

Referring to FIG. 4, a diagram of a curve 300 is shown illustrating an example quantization function of the block quantizer module 200 of FIG. 3. The curve 300 generally illustrates a quantization function where Q=3, M=3, F_POS=4, and F_NEG=3 (F_NEG=−F_POS+1_{Q}=−4+8−1=3).

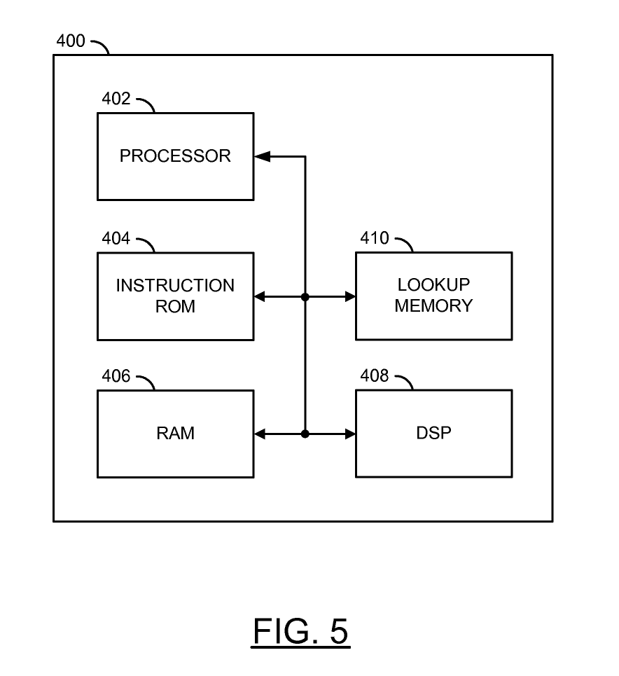

Referring to FIG. 5, a block diagram is shown illustrating an example processing unit 400 that may be configured (e.g., using hardware, software, firmware, microcode, etc.) to implement an encoder with a block quantizer in accordance with an embodiment of the present invention. In one example, the encoder 150 of FIG. 2 may be implemented using the processing unit 400. The processing unit 400 may include, but is not limited to, a block (or module) 402, a block (or module) 404, a block (or module) 406, a block (or module) 408, and a block (or module) 410. The module 402 may be implemented, in one example, as a processor (e.g., ARM, etc.). The module 404 may be implemented as a read only memory (ROM). The module 406 may comprise random access memory (RAM). The module 408 may implement a digital signal processor. The module 410 may implement a lookup table (LUT) or memory embodying, for example, rounding values in accordance with an embodiment of the present invention. The modules 402-410 may be connected together using one or more busses. In one example, the module 404 may store computer executable instructions for controlling the processor 402 and/or the processor 408.

The functions performed by the diagrams of FIGS. 1-3 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a first circuit configured to generate a first intermediate signal in response to a first input signal and a second input signal, wherein said first intermediate signal comprises a product of said first input signal and said second input signal;
a second circuit configured to generate a second intermediate signal by selecting between a first value and a second value in response to a sign of said first signal;
a third circuit configured to generate a third intermediate signal in response to said first intermediate signal and said second intermediate signal, wherein said third intermediate signal comprises a sum of said first intermediate signal and said second intermediate signal; and
a fourth circuit configured to generate an output signal in response to said third intermediate signal and a third input signal.

2. The apparatus according to claim 1, wherein said output signal comprises a quantized version of said first input signal.

3. The apparatus according to claim 1, wherein:
said first value comprises a first rounding coefficient;
said second value comprises a second rounding coefficient; and
said third input signal determines a quantization step size of said apparatus.

4. The apparatus according to claim 1, wherein:
said first circuit comprises multiplier;
said second circuit comprises a multiplexer;
said third circuit comprises an adder; and
said fourth circuit comprises a barrel shifter.

5. The apparatus according to claim 1, wherein said apparatus is part of a block quantizer circuit.

6. The apparatus according to claim 1, wherein said apparatus is part of a H.264 compliant block quantizer circuit.

7. The apparatus according to claim 1, wherein said apparatus is part of a video encoder circuit.

8. The apparatus according to claim 1, wherein said apparatus is part of a H.264 compliant video encoder circuit.

9. The apparatus according to claim 1, wherein said apparatus is implemented as an integrated circuit.

10. An apparatus comprising:
means for generating a first intermediate signal in response to a first input signal and a second input signal, wherein said first intermediate signal comprises a product of said first input signal and said second input signal;
means for generating a second intermediate signal by selecting between a first value and a second value in response to a sign of said first signal;
means for generating a third intermediate signal in response to said first intermediate signal and said second intermediate signal, wherein said third intermediate signal comprises a sum of said first intermediate signal and said second intermediate signal; and
means for generating an output signal in response to said third intermediate signal and a third input signal.

11. A method of quantizing a block of data values comprising the steps of:
generating a first intermediate signal in response to a first input signal and a second input signal, wherein said first intermediate signal comprises a product of said first input signal and said second input signal;
generating a second intermediate signal by selecting between a first value and a second value in response to a sign of said first signal;
generating a third intermediate signal in response to said first intermediate signal and said second intermediate signal, wherein said third intermediate signal comprises a sum of said first intermediate signal and said second intermediate signal; and
generating an output signal in response to said third intermediate signal and a third input signal.

12. The method according to claim 11, wherein each of said steps is performed by a processor chip executing computer executable instructions stored on a computer readable storage medium.

13. The method according to claim 11, wherein said first value and said second value are selected from a look-up table based upon said third input signal.

14. The method according to claim 13, further comprising generating a pair of rounding values for each of a plurality of step sizes of a quantizer.
